(19) United States
(12) Patent Application Publication
(10) Pub. No.: US 2012/0089267 A1
(43) Pub. Date: Apr. 12, 2012

(54) ELECTRICTY SUPPLY AND CONTROL APPARATUS

(76) Inventor: Paul Richard Jewell, Birmingham (GB)

(21) Appl. No.: 12/992,354

(22) PCT Filed: Jul. 2, 2010
(86) PCT No.: PCT/GB10/51098

§ 371 Date: Nov. 12, 2010

(30) Foreign Application Priority Data
Dec. 21, 2009 (GB) 0922208.4

(51) Int. Cl. G05D 11/00

(52) U.S. Cl. 700/295

(57) ABSTRACT

Electricity supply and control apparatus (10) for controlling the electricity power supply to a plurality of circuits in a building, comprises: a base unit (12) having a mains electricity supply input, a plurality of remotely-controllable switches (38), and a plurality of circuit breakers (42). The remotely-controllable switches (38) are electrically connected to respective first electricity output conductors (70) and first said circuit breakers (66), and second said circuit breakers (62) being electrically connected to respective second electricity output conductors (64) independently of the remotely-controllable switches (38). A remote control unit (16) is also provided which is in spaced communication with the base unit (12). The remote control unit (16) has a settable controller for controlling the remotely-controllable switches (38) whereby electricity to the respective first conductors (70) is interruptible. Monitoring means (18) is also provided and includes a monitoring element (80) at the base unit (12) for monitoring electricity consumption via the remotely-controllable switches (38), an input element (78) at the remote control unit (16) for inputting a unit cost of electricity, a determining element for determining a cost-saving based on an output of the monitoring element (80) when the controller operates the remotely-controllable switches (38) to interrupt the electricity supply and the inputted unit cost, and a display element (76) for displaying the determined cost-saving on the remote control unit (16).

The present invention relates to electricity supply and control apparatus, and more particularly but not necessarily exclusively to a building, such as a domestic residence, having such apparatus.

It is becoming of increasing concern that utility supplies and in particular electricity should be conserved wherever possible, thereby reducing harmful environmental emissions. This also has the benefit that costs to the consumer can be reduced.

WO2009/053695 does suggest apparatus for remotely controlling electricity supply to a plurality of appliances. This apparatus provides a dedicated remote unit which is plugged into a standard separate electricity outlet socket and to which the appliance is then electrically connected. Control of the remote unit takes place via a base controller sending control signals through the existing electrical wiring to the remote unit.

However, a separate remote unit is required for each electricity outlet socket, significantly increasing the cost of the apparatus. Furthermore, integrated wiring circuits without outlets, such as a lighting circuit, cannot be controlled using this apparatus. Additionally, no feedback of cost savings is provided thus encouraging a user to make use of the apparatus. Finally, the remote units have no safety cut-out element in the event of an electrical hazard being encountered.

The present invention seeks to provide solutions to all of these problems.

According to a first aspect of the invention, there is provided electricity supply and control apparatus for controlling the electricity power supply to a plurality of circuits in a building, the apparatus comprising: a base unit having a mains electricity supply input, a plurality of remotely-controllable switches, and a plurality of circuit breakers, the remotely-controllable switches being electrically connected to respective first electricity output conductors and first said circuit breakers, and second said circuit breakers being electrically connected to respective second electricity output conductors independently of the remotely-controllable switches; a remote control unit which is in spaced communication with the base unit, the remote control unit having a settable controller which controls the remotely-controllable switches whereby electricity to the respective first conductors is interruptible; and a monitoring element at the base unit which monitors electricity consumption via the remotely-controllable switches, an input element at the remote control unit which inputs a unit cost of electricity, a determining element which determines a cost-saving based on an output of the monitoring element when the controller operates the remotely-controllable switches to interrupt the electricity supply and the inputted unit cost, and a display element which displays the determined cost-saving on the remote control unit.

Preferable and/or optional features of the first aspect of the invention are set forth in claims 2 to 19, inclusive.

According to a second aspect of the invention, there is provided a building having a plurality of wiring circuits controllable by the electricity supply and control apparatus in accordance with the first aspect of the invention.

Preferably, one or more of the said wiring circuits has an electrical outlet socket which is remotely controllable by the electricity supply and control apparatus.

The invention will now be more particularly described, by way of example only, with reference to the accompanying drawings, in which:

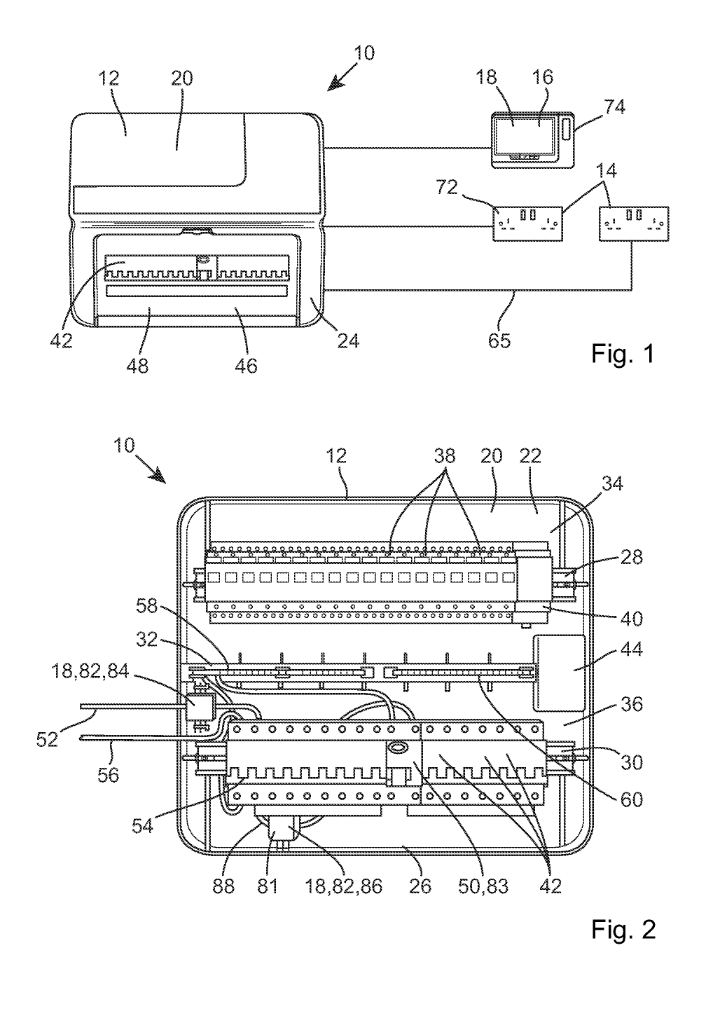

FIG. 1 shows an overview of electricity supply and control apparatus, in accordance with the first aspect of the invention;

FIG. 2 shows an interior of a base unit of the electricity supply and control apparatus, as shown in FIG. 1, and showing a first part of the interior wiring;

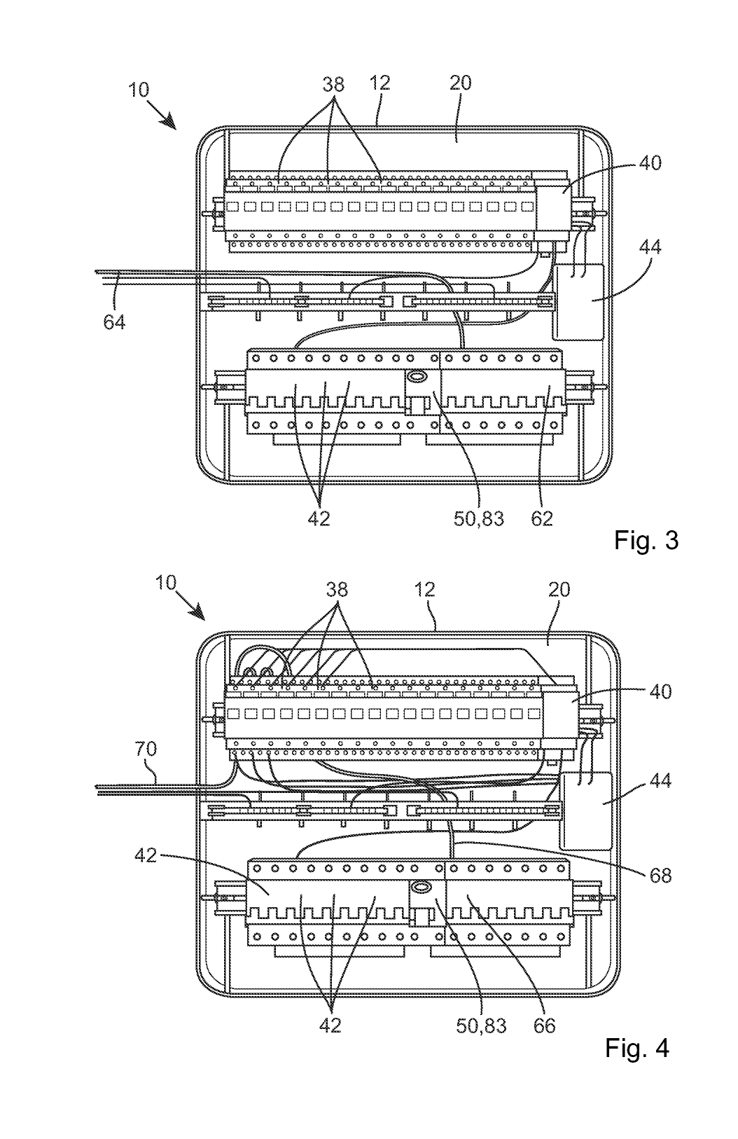

FIG. 3 is similar to FIG. 2, and shows a second part of the interior wiring;

FIG. 4 is similar to FIGS. 2 and 3, and shows a third part of the interior wiring;

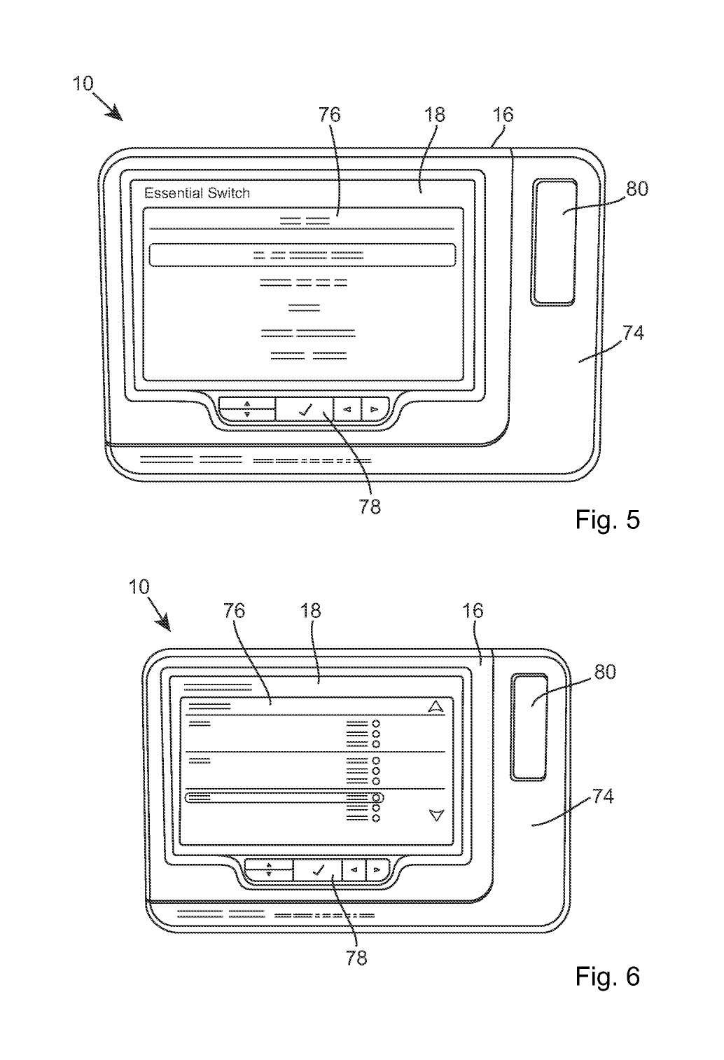

FIG. 5 is an enlarged view of the front of a remote control unit of the electricity supply and control apparatus, showing a first screen of a display; and

FIG. 6 a view similar to that shown in FIG. 5 of the front of a remote control unit and showing a second screen of the display.

Referring to the drawings, there is provided electricity supply and control apparatus 10 which comprises a base unit 12 which is typically connected to a plurality of wiring circuits to supply electricity to electricity outlet sockets 14 and/or electrical devices thereon, a remote control unit 16 for remotely controlling or group controlling the electricity flow on one or more of the wiring circuits supplied by the base unit 12, and monitoring means 18 for monitoring the supply of electricity to and/or from the base unit 12 and displaying a cost saving when utilising the remote control unit 16.

The base unit 12 comprises a base housing 20 having a back housing element 22 and a front housing element 24 which, when removably engaged with the back housing element 22 forms a cavity 26 therein. The base housing 20 is preferably moulded plastics, but may be any other suitable material.

The cavity 26 of the base housing 20 houses upper and lower DIN rails 28, 30 which are spaced apart. A partition wall 32 divides the cavity 26 into upper and lower compartments 34, 36, and the DIN rails 28, 30 are fixedly located in each of the upper and lower compartments 34, 36, respectively, so as to extend in parallel with each other.

A plurality of remotely-controllable switches 38 is detachably mounted to the upper DIN rail 28 in the upper compartment 34. The bank of switches 38 is powered by a power supply module 40 having, for example, a rectifier and step down transformer, to output a DC current from a mains AC power supply and via a circuit breaker 42, such as an MCB. This may be installed adjacent to existing circuit breaker devices, allowing existing circuit breakers to be used or ‘tapped into’ for switching certain circuits. This would make installation potentially less costly.

A control module 44 is also included at the partition wall 32 for controlling the switches 38 independently of each other but also simultaneously as necessity requires, and this control function will be described in more detail hereinafter.

A plurality of the circuit breakers 42 is detachably mounted to the lower DIN rail 30 in the lower compartment 36. This is convenient, since the circuit breakers 42 are then accessible via an access opening 46 in the front housing element 24, allowing manual operation where necessary, for example for resetting. The access opening 46 is preferably closeable via a hinged access cover 48, typically being transparent. By locating the circuit breakers 42 in this lower position, the base housing 20 can be accommodated in the same position as many existing consumer units whilst retaining almost identical access to the circuit breakers 42.

Preferably, once the back housing element 22 and the front housing element 24 are connected together, the remotely-controllable switches 38 are not manually accessible.

The remotely-controllable switches 38 and the circuit breakers 42 can be individually mountable on their respective DIN rails 28, 30, enabling modular configuration and expansion dependent on the installation requirements.

A residual current device 50, hereinafter RCD, or a Residual Current Circuit Breaker, hereinafter RCCB, is also preferably provided on the lower DIN rail 30 to disconnect a circuit on detection that the electric current is not balanced between the energized conductor and the return neutral conductor, for example, by current leakage through the body of a person who is grounded and accidentally touching the energized part of the circuit.

Referring to FIG. 2, a main energised or Live conductor 52, either directly from an electricity supplier via the main national power grid in the case where the base unit 12 is a dedicated consumer unit or from a consumer unit to the base unit 12 where the base unit 12 is an add-on or supplemental unit, enters the base housing 20 and is connected through a main power switch 54 and the RCD 52 or RCCB to the circuit breakers 42. A main neutral conductor 56 extends from the RCD 52 or RCCB to a neutral bar element 58 provided on the partition wall 32, and then back to the main power switch 54 and out of the base housing 20. A Live bar element 60 is also provided on the partition wall 32.

In FIG. 3, one or more first said circuit breakers 62 have first conductors 64 extending therefrom for supplying electricity directly to wiring circuits 65 which ordinarily are not to be turned off. Such circuits may be ring main circuits, and for example may include a lighting circuit, refrigerator circuit, and/or security camera or alarm circuit.

In FIG. 4, a specific said circuit breaker 66 has a second conductor 68 which is electrically connected to a respective said remotely-controllable switch 38. A third conductor 70 extends from the remotely-controllable switch 38 to a specific electricity outlet unit 72, such as a socket, or an electrical device, such as a light. This arrangement is repeated for all non-essential outlets 72 and devices, thus creating a dedicated sub-bank of circuit breakers 66 and associated remotely-controllable switches 38 for controlling specific dedicated wiring circuits and devices thereon.

The control module 44 is electronic and is wired to each remotely controllable switch 38 requiring operation.

Referring to FIGS. 1, 5 and 6, the remote control unit 16 is preferably hard wired for communication to the base unit 12 and separately to a mains electricity supply. The remote control unit 16 is sufficiently spaced to be positionable for easy access, for example, next to an exit and/or entrance of a building. The remote control unit 16 includes a remote housing 74 which is typically smaller than the base housing 20, but similarly styled and preferably formed of similar material.

A display screen 76 is provided on the front surface of the remote control unit 16, a user interface 78 is provided in this case below the display screen 76, and a main control button 80 is provided adjacent to one side.

The display screen 76 may be a touch screen and thus the user interface 78 may be software based instead of electromechanical buttons as in the present embodiment.

The display screen 76 forms part of the monitoring means 18 mentioned above. The user interface 78 accesses a controller also part of the monitoring means 18 and within the remote control unit 16. The user interface 78 acts as an input element for inputting data, such as a unit cost of the actual electricity supply being charged by the present supplier, and for selecting which remotely-controllable switches 38 should be operable. The controller also includes a calculator or other determining element 81 which, based on the inputted unit cost data, can calculate and output a total cost for a determined period.

The monitoring means 18 also includes two monitoring elements 82, in this case being meter clamps. The monitoring elements 82 are within the base unit 12 and output signals to the remote control unit 16. A first monitoring element 84 is provided on the main energised or Live conductor 52, and the second monitoring element 86 is provided on an in feed 88 to the sub-bank of circuit breakers 66 feeding the remotely-controllable switches 38.

It may be feasible to dispense with one or other of the monitoring elements 82, whereby the controller in the remote control unit 16 can determine a reduction in electricity consumption by monitoring a status of the remotely-controllable switches 38 and a subsequent drop in monitored current.

To enable communication between the base unit 12 and the remote control unit 16, a transceiver element is provided in each element, and in the case of the base unit 12, it is conveniently integrated as part of the control module 44.

Beneficially, the control module 44 also monitors, for example, by resistance or impedance, each remotely-controllable switch 38, and thus outputs an active signal to the remote control unit 16 indicating that the switch 38 in question is available for selection due to a specific conductor being connected thereto. Via the user interface 78 and the display screen 76, a user can then rename a specific switch 38 which is indicated as being connected to a wiring circuit to a more suitable and apparent name, such as ‘Living Room—Socket 1’. Switches 38 can then be grouped, again via the user interface 78 and the display screen 76 so that a group or groups can be controlled simultaneously using the main control button 80.

The main control button 80 would typically be operated by a user leaving an area in the building or the building itself, for example, when finishing work or going to bed. Once the main control button 80 is operated, the controller of the remote control unit 16 outputs a signal to the control module 44 which operates the pre-selected group of remotely-controllable switches 38 in the base unit 12. Operation of these switches 38 interrupts the flow of electricity to their respective circuits. The monitoring elements 82 output signals indicative of the drop in electricity consumption, and the specific reduction in electricity consumption through the switched wiring circuits can be determined at the remote control unit 16. With the display of the remote control unit 16 activated, a real time on-going cost-saving can be displayed, encouraging the user to utilise the apparatus 10 at every opportunity.

The remote control unit 16 may include a standby function so that it powers down after a predetermined period, again to save further costs.

As circuits are added or removed, it is a simple matter to add or remove remotely-controllable switches 38 and circuit breakers 42 as necessity dictates.

It is also possible to include internet connection means, typically being in the form of a modem, router and/or wired or wireless Ethernet card for interfacing with an internet access point. This can be in the base unit 12 or the remote control unit 16, and would allow the remote control unit 16 to update the unit cost, typically being per kilowatt or per kilowatt hour, automatically from the present electricity supplier.

The electricity supply and control apparatus 10 can be provided as a kit of parts, thus allowing retro-fitting to existing installations and incorporation into new build projects.

Although the remote control unit is preferably hard-wired to the base unit, it could alternatively or additionally be in wireless communication.

The remote control unit may control more than one base unit. In this case, the remote control unit may be hard wired and/or wirelessly connected to the or each base unit. Such a single network including multiple base units and one or more remote control units would typically be connected together via an addressable selectable switch.

Conveniently, the remote control unit and the base unit may utilise a building control system such as Java Application Control Engine or JACE® thereby allowing interface via LON/BACnet communication. This would also be convenient in allowing remote web access to the system by a user, trending of energy usage over time, energy feedback to an energy supplier, interfacing with smart meters via custom programming, and communication to an assigned DRAS server for event energy shed modes. The DRAS server or similar may also function as a data/trending storage tank. Conveniently, a software enabled interface, such as via a mobile communications device, and more particularly a smartphone such as an iPhone® application, could be utilised to remotely control the base unit. This may be in addition to or instead of the aforementioned remote control unit, and would add a level of convenience for the user. Access would be via a suitable wireless protocol, such as Wi-Fi, Bluetooth®, a proprietary wireless protocol or bespoke wireless protocol specifically developed for this application. The mobile communications device would preferably access the, for example, DRAS, server via a web-based portal allowing remote user control.

When utilising a building control system, such as JACE®, a UPS surge protector or battery backup may also be beneficial in the case of energy spikes or outages causing lockup.

Conveniently and to meet regulations in some jurisdictions, the high side line voltage area, for example including relays, may be physically isolated from the low side switching voltage, such as at a relay interface board or boards, by use of a physical barrier, casing or cover.

At least one so-called ‘smart breaker’ or ‘smart relay’ 83 can also be utilised. This would typically be located on the base unit circuit panel. It would preferably utilise programmable technology using solid-state power control that makes it possible to monitor and limit current flow during short circuits, retrieve high current values, cycle times, and other information from breakers or switches with internal memory storage. This breaker allows trip points and speed profiles necessary to meet the applications specifications to be specifically pre-programmed by a user or installer, and in the present case it would enable turning off and on of wall circuits. The smart breaker may also include a sensing circuits that feeds information such as voltage values, current flows, and circuit status back to PLCs (JACE) and or other control units and can be reset remotely, for example, via the remote unit. The smart breaker may also provide an analog output signal proportional to current. Another benefit of using a smart breaker electronic circuit protection device is space saving afforded by having breakers doing double duty as also a power control relay. Smart circuit breakers offer all the features of a solid state relay in addition to over current trip features of a circuit breaker. The smart breaker allows remote switching to isolate a specific associated circuit should there be a problem, whilst also enabling manual override, particularly for circuits which are deemed non-essential. The smart breaker may also include an earth leakage safety re-set.

The base unit and/or remote control unit may also be weatherproof for wet, humid or exterior area applications.

Furthermore, the apparatus may be configured to operate on world voltages, such as 100 volts to 250 volts and more particularly 120 volts and 240 volts at a frequency of at least 50 hertz and/or 60 hertz.

The remote control unit may include a battery backup system in the event of power failure to ensure at least that settings are not lost.

It is also feasible to include a supplementary control unit analogous to the remote control unit on the base unit to backup the functions provided by the remote control unit. Again, this is in the event that, for example, the remote control unit is damaged or generates a fault. In this way, the apparatus can still be utilised whilst the remote control unit is repaired. In this case, the supplementary control unit may be integrally formed as one-piece with the base unit, or it may be docked allowing removal.

It is thus possible to provide electricity supply and control apparatus which enables a non-switched wiring circuit for essential electrical devices and a remotely-switchable wiring circuit for non-essential electrical devices. It is also possible to provide such apparatus which also imparts user feedback regarding a cost-saving due to switching the switched wiring circuit to interrupt an electricity flow, thereby encouraging continued and frequent use.

The embodiments described above are provided by way of examples only, and various other modifications will be apparent to persons skilled in the art without departing from the scope of the invention as defined by the appended claims.

1. Electricity supply and control apparatus for controlling the electricity power supply to a plurality of circuits in a building, the apparatus comprising: a base unit having a mains electricity supply input, a plurality of remotely-controllable switches, and a plurality of circuit breakers, the remotely-controllable switches being electrically connected to respective first electricity output conductors and first said circuit breakers, and second said circuit breakers being electrically connected to respective second electricity output conductors independently of the remotely-controllable switches; a remote control unit which is in spaced communication with the base unit, the remote control unit having a settable controller which controls the remotely-controllable switches whereby electricity to the respective first conductors is interruptible; and a monitoring element at the base unit which monitors electricity consumption via the remotely-controllable switches, an input element at the remote control unit which inputs a unit cost of electricity, a determining element which determines a cost-saving based on an output of the monitoring element when the controller operates the remotely-controllable switches to interrupt the electricity supply and the inputted unit cost, and a display element which displays the determined cost-saving on the remote control unit.

2. Electricity supply and control apparatus as claimed in claim 1, further comprising at least one programmable smart breaker in communication with at least one said remotely-controllable switch and said circuit breaker which monitors and/or controls at least one of current flow, high current values.

3. Electricity supply and control apparatus as claimed in claim 2, wherein the smart breaker includes a sensing circuit which is connected to a building control system provided at least in part within the base unit, the sensing circuit outputting at least one of voltage and current values to the building control system.

4. Electricity supply and control apparatus as claimed in claim 3, wherein the building control system includes a web-based portal for remote user access.

5. Electricity supply and control apparatus as claimed in claim 4, wherein remote user access is via a mobile communications device.

6. Electricity supply and control apparatus as claimed in claim 1, wherein the said monitoring element comprises a first monitoring element on a main Live conductor entering the base unit, and a second monitoring element on a secondary Live conductor between a master switch at the base unit and the first said circuit breakers.

7. Electricity supply and control apparatus as claimed in claim 1, wherein the monitoring element is a meter clamp having an output to the determining element.

8. Electricity supply and control apparatus as claimed in claim 1, wherein the determining element is in the remote control unit.

9. Electricity supply and control apparatus as claimed in claim 1, wherein the input element is one or more buttons provided on the remote control unit for manually inputting the unit cost.

10. Electricity supply and control apparatus as claimed in claim 9, wherein a button is a virtual button provided on a touch screen display of the remote control unit.

11. Electricity supply and control apparatus as claimed in claim 1, wherein the remotely-controllable switches and the circuit breakers are mounted in spaced relationship within a base housing of the base unit.

12. Electricity supply and control apparatus as claimed in claim 11, wherein the remotely-controllable switches are removably mounted on a first DIN rail, and the circuit breakers are removably mounted on a second DIN rail which is spaced from the first DIN rail.

13. Electricity supply and control apparatus as claimed in claim 11, wherein the circuit breakers are accessible for manual operation via an opening in the base housing, and the remotely-controllable switches are enclosed within the base housing.

14. Electricity supply and control apparatus as claimed in claim 1, further comprising a control module within the base unit which monitors the existence of a said first electricity output conductor at a said remotely-controllable switch and outputs a unique identifier to the remote control unit to enable user selection.

15. Electricity supply and control apparatus as claimed in claim 1, further comprising a power supply module for powering the remotely-controllable switches separately of the circuit breakers.

16. Electricity supply and control apparatus as claimed in claim 1, further comprising a transceiver element in the base unit for communication with the remote control unit.

17. Electricity supply and control apparatus as claimed in claim 1, wherein the input element includes internet connection means for automatically connecting to a utility supplier to obtain a unit cost of the electricity being supplied.

18. Electricity supply and control apparatus as claimed in claim 1, wherein the base unit is a consumer unit which interfaces building wiring circuits with a mains supply wiring from an electricity supplier.

19. Electricity supply and control apparatus as claimed in claim 1, in the form of a kit of parts.

20. A building having a plurality of wiring circuits controllable by the electricity supply and control apparatus as claimed in claim 1, wherein one or more of the said wiring circuits has an electrical outlet socket which is remotely controllable by the said electricity supply and control apparatus.

21. (canceled)
